(19) United States
(12) Patent Application Publication
(10) Pub. No.: US 2005/0018073 A1
(43) Pub. Date: Jan. 27, 2005

(54) Camera mounting and image capture

(76) Inventor: Maurizio Pilu, Bristol (GB)

Correspondence Address: HEWLETT-PACKARD COMPANY;Intellectual Property Administration, P.O. Box 272400, Fort Collins, CO, 80527-2400, US

(21) Appl. No.: 10/877,676

(22) Filed: Jun. 25, 2004

(30) Foreign Application Priority Data
Jun. 27, 2003 (GB) 0314978.8

(51) Int. Cl. H04N 5/225

(52) U.S. Cl. 348/375

(57) ABSTRACT

An exemplary camera embodiment is adapted for detection of a mounting arrangement. The embodiment comprises detecting at least one of a plurality of mounting inputs associated with mounting of an image capture device; identifying one of a plurality of image capture settings associated with the detected mounting input; and controlling capture of at least one image by the image capture device in accordance with the identified image capture setting.

### FIELD OF INVENTION

Embodiments relate to image capture, and more particularly, to a system and method for configuring image capture using an image capture device.

### DESCRIPTION OF PRIOR ART

There are special problems of image capture for cameras that may be worn on a user's body or mounted on a user's bicycle or the like. These are, for example, subject to different modes of movement, depending where on the body the camera is mounted or on what part of the bicycle. Disadvantages arise when the particular type of motion encountered for a particular mounting of the camera cannot be catered for when a picture is captured with a camera.

It is desirable to improve image processing and image capture for such cameras.

### SUMMARY OF INVENTION

Briefly described, one exemplary camera embodiment is adapted for detection of a mounting arrangement. The embodiment comprises detecting at least one of a plurality of mounting inputs associated with mounting of an image capture device; identifying one of a plurality of image capture settings associated with the detected mounting input; and controlling capture of at least one image by the image capture device in accordance with the identified image capture setting.

### BRIEF DESCRIPTION OF THE DRAWINGS

For a better understanding of the invention, and to show how embodiments of the same may be brought into effect, specific embodiments will now be described, by way of example, with reference to the accompanying drawings, in which:

FIG. 1a is a schematic perspective view of an image capture device operable to be mounted in a number of different locations;

FIG. 1b is a schematic rear view of the image capture device shown in FIG. 1a showing control features;

FIG. 2 is a schematic perspective view of the image capture device secured in position on a bicycle;

FIG. 3 is a schematic perspective view of the image capture device mounted on a user's body;

FIG. 4a is a schematic perspective view of a second embodiment of image capture device;

FIG. 4b is a schematic rear view of the second embodiment shown in FIG. 4a;

FIGS. 5a and 5b are perspective and plan views respectively of a clip mounting device for the image capture devices;

FIG. 6 is a schematic perspective view of a strap mounting device for the image capture devices;

FIGS. 7a and 7b are schematic perspective views of the second embodiment of image capture device incorporating the strap attachment device;

FIG. 8 is a block diagram of an embodiment of an image capture device; and

FIG. 9 is flow chart of a process used by the image capture device embodiment.

### DETAILED DESCRIPTION

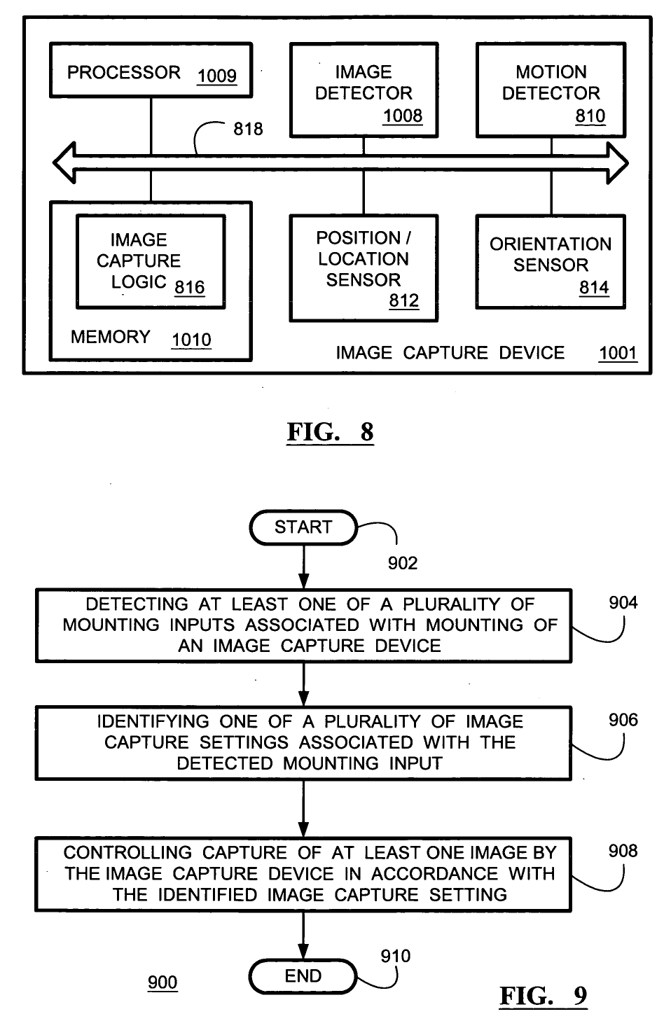

A first embodiment of an image capture device 1001, also referred to herein as camera 1001, is shown in FIG. 1a. The image capture device 1001 has a lens 1006, an image detector 1008 and a memory 1010 (the latter shown in dashed lines to indicate that they are internal). The memory 1010 may comprise a single or multiple memories and contains instructions for control of the camera, captured images, and (in some embodiments) an image buffer for temporary image storage or for storage of images from an image stream—in practice, it is likely that different memory components will be used for each of these purposes, perhaps with permanent memory for control firmware and removable memory for image capture. The camera 1001 incorporates controls 1012 and 1014, which are the usual controls for selecting and varying functions of an image capture device such as a video or still image camera. Processor 1009 for controlling the camera is also included in the form of a conventional microprocessor or computing device comprising a microprocessor. There may also be a bus 818 (FIG. 8) or other means by which the processor 1009 is placed in communication with the detector 1008, the memory 1010 and the user interface controls 1012 and 1014.

FIG. 1b shows a rear view of the device shown in FIG. 1a. Additional first to third user interface buttons 1003, 1004 and 1005 are shown in the rear view (these buttons are also in communication with the processor 1009). The first user interface button 1003 can be used to select a first mounting mode or arrangement for attaching the image capture device 1001 to an object (such as a vehicle, a person or an animal). For example, a first arrangement may be that the camera 1001 is to be located on a user's head 712 (see FIG. 3). When button 1003 is pressed, settings of the camera are varied to take into account the particular circumstances of the camera 1001 being mounted on the user's head 712. These features include the ability to account for head movement, using existing image stabilisation techniques, such as those discussed below. Furthermore, stabilisation parameters, picture taking frequencing criteria, exposure settings, and field of view may all have particular settings based on the camera being head mounted as opposed to being mounted elsewhere on a user's body.

There are several kinds of control that may be involved, and which may be provided by the image settings associated with a mounting arrangement. One kind of control is to configure the camera so that any subsequent capture of an image will have certain camera settings. That is, the camera is controlled such that it will take pictures with a particular field of view, exposure, etc. Another kind of control is over a rule for taking of pictures, where this process is automatic rather than under direct user control.

This will typically involve taking pictures when a particular condition is met—lapse of time since the past image captured, or presence of a particular object in the field of view (for which there will typically need to be regular capture of images into an image buffer and analysis of images in that image buffer to see whether a capture condition, such as the presence of a face, is met). Such capture conditions are addressed further below. A further kind of control is in determining post-capture processing of an image—either of a still image, a passage of video, or of images in an image buffer to produce a still image or a passage of video. Image stabilisation is an example of this kind of control.

The second user interface button 1004 is used to select a second mounting mode or arrangement. For example, a second arrangement may be on a user's chest pocket 703 (see FIG. 3), for example. Settings associated with this exemplary second arrangement takes into account the field of view experienced by the image capture device 1001, which will be a lower field of view than would be the case if the image capture device 1001 were mounted on the user's head 712. Also, image stabilisation (discussed below) may have a different characteristic when compared to the characteristic when the image capture device 1001 is located on the user's head 712, or elsewhere. Side to side movement is less when not a user's head, for example.

The third user interface button 1005 selects a third mounting mode or arrangement. For example, a third arrangement may be the location of the image capture device 1001 on the user's belt 707 (see FIG. 3). Again, the field of view compared to the mounting positions mentioned above is different for a belt-mounted image capture device 1001. Also, movement of the user is likely to have a different characteristic, and so require different image stabilisation, than it would for different location positions.

One of the major difficulties of motion filtering and motion stabilisation is to understand what the intentional motion of the camera is in order to preserve it in the stabilized output image sequence. For instance, when panning a camcorder, warping a current frame to a reference frame too far back in time would cause the “saw tooth” effect in the output sequence, resulting in a jerking panning movement.

Detecting the intentional motion patterns can also be useful to select the correct stabilization mode and parameters (see J. C. Tucker, A. de San Lazaro, “Image stabilisation for a camera on a moving platform”, Proceedings of IEEE Pacific Rim Conference on Communications Computers and Signal Processing, Vol. 2, pp 734-7, May 1993 and M. Oshima, et al., “VHS Camcorder with Electronic image stabiliser”, IEEE Transactions on Consumer Electronics, vol. 35, no 4, p 49-758, June 1989, all of which are incorporated by reference herein). For example, if the camera is stationary high frequency vibration should be totally removed, whereas when walking the filtering should be less strict.

Thus, except for the simplest of approaches or when the motion correction is through a mosaic representation, most methods have at least a simple detection of the intentional camera motion.

The techniques employed to detect the type of motion vary widely. For example, one embodiment employs classification of a time-sequence of motion measurements. For instance Oshima et al. (mentioned above) analyse the rotation angle 0 W of the camera with respect to a fixed point in space and depending on whether that is small, varying in one direction or varying in two directions, they infer whether the user is holding the camera stationary, panning or walking, respectively. In S.-J. Ko, S.-H. Lee, K.-H Lee, “Digital image stabilising algorithms based on bitplane matching”, 1998 International Conference on Consumer Electronics, pp. 617-22, August 1998 (incorporated by reference), a panning motion is detected by integrating a linear combination of a dampened global motion vector with the current vector; a panning camera has motion vectors in a dominant direction and hence by thresholding the integrated value one can determine if a dominant motion occurred over time. In Y. S. Yao, P. Burlina, R. Chellappa, T. H. Wu, “Electronic image stabilistion using multiple visual clues”, Proceedings of the IEEE International Conference on Image Processing, vol 1, pp. 1914, October 1995 (incorporated herein by reference), the authors do not classify motion, but rather separate rotational and translational components of the camera motion and leave only the rotational ones to be filtered, leaving camera translation unaffected. Tucker and De Lazaro (above) analyse the configuration over a brief period of time of four motion vectors in four quadrants and classify the motion into scaling, panning, and vibration using fuzzy logic.

The controls 1012 and 1014 are augmented by further controls 1002 operable to perform further functions typically associated with an image capture device, be it a still image capture device or video image capture device.

In FIG. 3, a user 700 is shown wearing embodiments of the image capture device 1001 attached to glasses 711 on his head 712; on his chest pocket 703; or on his belt 707. The controls 1003, 1004 and 1005 (FIG. 1b) are used to select the location positions of the image capture device 1001 shown in FIG. 3. The user may manually select on of the controls 1003, 1004 and 1005 to configure image capture as described herein.

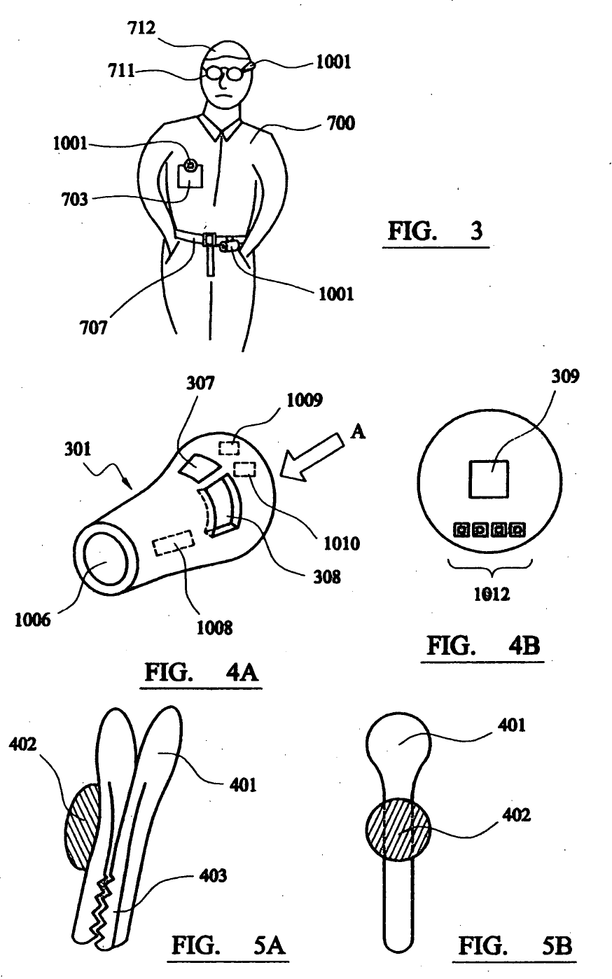

FIG. 4a shows a second embodiment of image capture device 301 having a lens 1006, a detector 1008 and a memory 1010. The image capture device 301 has a number of parts in common with image capture device 1001 (FIGS. 1a, 1b and 3). Like parts are given like reference numerals.

First, second and third image capture device mounting location buttons 307, 308 and 309 respectively (see FIGS. 4a and 4b) are provided on the image capture device 301 and take the form of buttons or pressure pads.

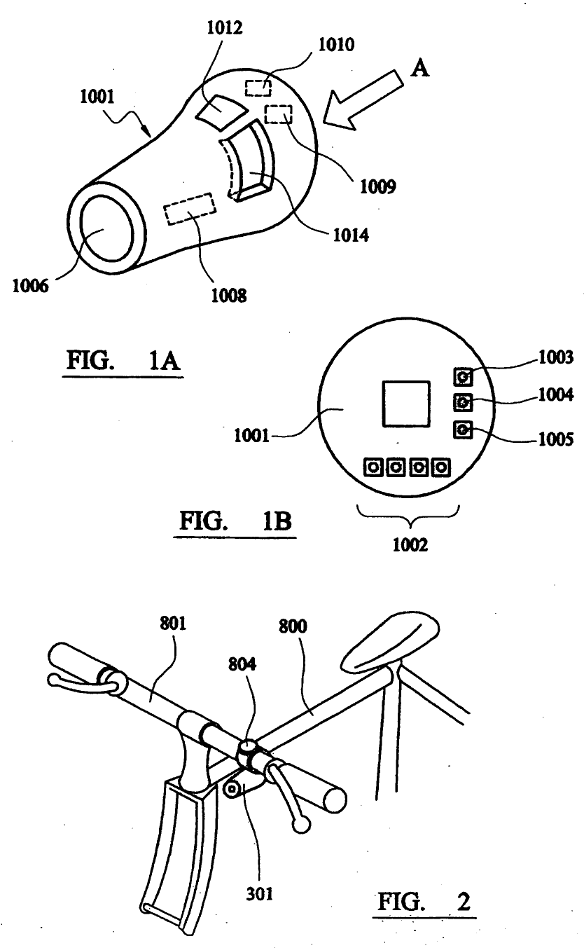

The first mounting location button 307, when depressed, indicates to the image capture device 301 that a particular mounting position has been chosen. In the case of the first mounting location button 307 it may indicate that a hook and pile fastener strap 804 (see FIGS. 2 and 6) has been used to secure the image capture device 301 to a vehicle, such as the bicycle handle bar 801 of a bicycle 800 (FIG. 2). The strap 804 is shown in greater detail in FIG. 6 and includes a mount plate 502 on which the image capture device may be secured at the image capture device mounting location buttons 307, 308 or 309. The mount plate 502 actuates the button 307, 308, 309 to select the mounting location. In one embodiment, proximity of the mount plate 502 to one of the buttons 307, 308, 309 depresses that button.

FIGS. 7a and 7b show the strap 804 secured to the second mounting location button 308, causing depression of a button by the mount plate 502 thereof. The different orientation of the strap in FIGS. 7a and 7b indicates a different mounting position, which may be indicated to the processor 1009 (FIG. 4a) by the shape, orientation or position of the mount plate 502. This may indicate different likely motion and/or that a rotation of 90° is required for the image in one orientation with respect to the other.

When mounting the image capture device 301 on the handle bars 801 of the bicycle 800 (FIG. 2) parameters such as those discussed above in relation to the manual selection controls 1003, 1004 and 1005 (FIG. 1b) of the first embodiment are also relevant here. When mounting on handlebars an image stabilisation system more able to cope with movement associated with bicycle movement may be triggered, together with compensation for a different field of view, which is likely to be lower than if it were attached to a user's head or his chest.

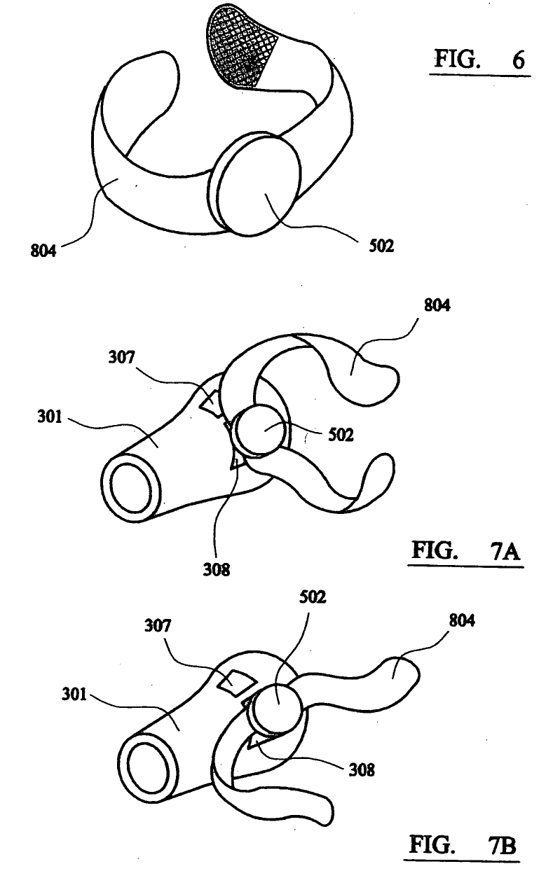

FIGS. 5a and 5b show a clip 401, which has a mounting plate 402. The mounting plate 402 is arranged to be attached to one of the mounting location buttons 307, 308 or 309 on the image capture device 301 shown in FIG. 4a and cause actuation, such as by depression in one embodiment, of that button. One embodiment of the clip 401 is sprung (opened) and has teeth 403 to provide a secure attachment to, for example, a user's pocket 703, as shown in FIG. 3 for the first embodiment. The use of the mounting location buttons 307, 308, 309 with the clip 401 may provide an indication to the image capture device 301 that an image captured by the image capture device 301 should be rotated by 90°, given the orientation of the image capture device 301 when the clip is secured to a user's chest pocket 703. Also, the same clip 401 may be used to secure the image capture device 301 to a user's belt 707, as shown in FIG. 3 for the first embodiment. Rotation of the image through 90° is also likely to be needed in this position. Different orientations of the clip may give rise to a different requirement for images taken by the image capture device 301, such as a rotation through 90° or a different motion stabilisation.

The image capture mounting location button 309 as shown in FIG. 4b may be used to indicate securing the image capture device 301 in a forward pointing orientation by use of a suitable camera mounting device.

In one embodiment, all of the image capture device mounting location buttons, 307, 308, 309 are triggered by depression of the buttons 307, 308, 309. Depression of which button indicates to the image capture device 301 a likely orientation for the image device. Further indications may be given to the image capture device 301 concerning particular image stabilisation, picture taking or image capture frequency, picture or image capture exposure, field of view, based on expected uses of the device in the given location. In addition to stabilisation (discussed above) parameters may be varied by analysis of images based on subjects of likely interest. Techniques used may be similar to those as described in Y. Nakamura, J. Ohde, Y. Otha, “Structuring personal activity records based on attention: Analyzing videos from a head-mounted camera”, in International Conference on Pattern Recognition, Barcelona, September 2000, “Unsupervised Clustering of Ambulatory Audio and Video”, Clarkson, Brian P. and Pentland, Alex, (1998), Proceedings of the International Conference of Acoustics, Speech and Signal Processing, Phoenix, Ariz., 1999 (all of which are incorporated by reference herein). These techniques may be used to select images of interest for use by control means 1009, such as a computing device, of the camera to analyse an image field for subjects of likely interest.

A further alternative, which could be provided in addition to the embodiments described above, would be to augment information from the controls 1003, 1004, 1005 or the mounting location buttons 307, 308, 309 by detection of the location or orientation of mounting attachments, such as the plate 402 on the clip 401 or the plate 502 on the strap 804. For example, based on initial measurements from motion detectors 810 (FIG. 8) which may be provided within the image capture device 301/1001, the image capture device 301/1001 may be able to determine if it is mounted backwards with respect to a dominant direction of motion, when for example it is mounted on a bicycle or on a user 700 who is moving. An example of a suitable motion detector would be a piezoelectric gyroscopic motion detector, such as the Murata Enc 03J.

An example of the way in which motion detected by the motion detectors may be classified can be found in “Context Awareness by Analysing Accelerometer Data,” Randell and Muller, “The Fourth International Symposium on Wearable Computers,” pp. 175-176, IEEE Computer Society, October 2000 (incorporated by reference herein). Any such motion detectors 810 (FIG. 8) may be used depending upon the embodiment.

The relevance of the mounting position of the image capture device 1001/301 can be taken into account, for example, by triggering the image capture device 301/1001 to capture faces when they are within view, based on a particular mounting position. For example, when the image capture device 1001 is head mounted, then faces are of more relevance, whereas faces would be of less relevance, or more difficult to capture successfully, when the image capture device 1001 was mounted on a user's belt 707 or on handlebars 801 of the bicycle 800. Furthermore, when mounted on handlebars 801, cars may be of less importance when identified, because they are likely to be encountered many times whilst a user is on a bicycle.

A mounting arrangement may be an indication of where and/or in what orientation the image capture device is mounted or secured, such as a location/orientation on a user's body or a location/orientation on a piece of equipment or a vehicle, such as a bicycle, controlled by the user.

FIG. 8 is a block diagram of an embodiment of an image capture device.

Internal component, among others not shown, include the above described image detector 1008, processor 1009 and memory 1010. Also included are position sensor 812, orientation sensor 814 or motion detector 810. Image capture logic 816 resides in memory 1010 and controls image capture as described herein.

The mounting arrangement may be detected. In one embodiment, arrangement is detected by the use of a mounting position detection means, which may be at least one location sensor 812 (FIG. 8), such as a pressure pad or button. The mounting position detection means are preferably operable, when activated, to indicate to the processor which of a plurality of mounting arrangements to adopt.

The mounting position detection means, as described herein in the various embodiments, may be located on a side of the image capture device, on a base of the image capture device and/or on a rear of the image capture device.

FIG. 8 is a block diagram of an embodiment of an image capture device. Internal components, among others not shown, include the above described image detector 1008, processor 1009 and memory 1010. Also included are position (or location) sensor 812, orientation sensor 814 or motion detector 810. Image capture logic 814 resides in memory 1010 and controls image capture as described herein.

The mounting arrangement may be detected by one or more sensors 812, 814, 816 (FIG. 8) operable to allow a mounting location of the image capture device to be inferred, preferably by an algorithmic method. The sensors 812, 814, 816 for inferencing may include at least one position sensor 812, orientation sensor 814 or motion detector 810. The processor 1009 (FIGS. 1 and 8) may be operable to infer a mounting location of the image capture device based on an output of a sensor, based on the type of movement detected.

The sensors for inferencing, in one embodiment, may include the image detector 1008 of the image capture device 1001. The processor 1009 is preferably operable to analyse the output of the image detector 1008 to infer a characteristic motion of the image capture device 1001, the characteristic motion preferably being linked to a given mounting location.

As described herein, associated with a mounting arrangement, there are image capture settings for use by the processor 1009 in controlling image capture. These may be, for example, based on a likelihood of a user showing interest in a given subject, based on images likely to be captured in a given mounting arrangement. The choice of image capture may be based on an output of at least one motion sensor 810, or of image stabilisation means of the control means. In one embodiment, the means includes selected ones of the above-described sensors 812, 814, 816, processor 1009 and image capture device logic 816.

The camera (image capture device) 1001 may be a still camera or may be a video camera, or both, depending upon the embodiments.

The processor 1009 in one embodiment preferably has access to information relating to a plurality of possible mounting arrangements, stored in memory 1010 or in another suitable memory medium. Each mounting arrangement may specify settings for the image capture device 1001, wherein the settings may be mounting location specific. The settings may include a motion stabilisation parameter, picture taking frequency, picture exposure, and/or field of view setting. The settings may be based on an expected type of use of the image capture device in a given mounting mode.

In some embodiments, the harness may be or comprise a clip or a strap or another fastening device.

In some embodiments, the mounting arrangement may be specifiable using a user interface, which may be one or more buttons/switches, operable to be activated by the user. The user interface may incorporate a button/switch for a given mounting arrangement, which button/switch, when activated, preferably indicates to the processor which mounting arrangement to adopt. User-selected mounting arrangements may include head-mounted, chest-mounted and/or belt-mounted arrangements.

FIG. 9 is flow chart 900 of a process used by the image capture device 1010 embodiment. The flow chart 900 shows the architecture, functionality, and operation of a possible implementation of the software for implementing the image capture logic 816 (FIG. 8). In this regard, each block may represent a module, segment, or portion of code, which comprises one or more executable instructions for implementing the specified logical function(s). It should also be noted that in some alternative implementations, the functions noted in the blocks may occur out of the order noted in FIG. 9 or may include additional functions without departing significantly from the functionality of the process of FIG. 9. For example, two blocks shown in succession in FIG. 9 may in fact be executed substantially concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure.

The process of flow chart 900 starts at block 902. At block 904, at least one of a plurality of mounting inputs associated with mounting of an image capture device is detected. At block 906, one of a plurality of image capture settings associated with the detected mounting input is identified. At block 908, capture of at least one image by the image capture device in accordance with the identified image capture setting is controlled. The process ends at block 910.

In other embodiments, there is provided a method of configuring a camera comprising an image detector, a processor and a memory, the method comprising:
identifying a plurality of mounting inputs and storing image capture settings associated with each of the plurality of mounting inputs in the memory; the processor detecting one of the plurality of mounting inputs; and the processor obtaining the image capture settings associated with the said one of the plurality of mounting inputs from the memory and controlling capture of images by means of the image detector in accordance with the said image capture settings.

In other embodiments, there is provided camera apparatus comprising a camera mounting and a camera. The camera comprises an image detector, a processor and a memory. The camera mounting comprising a mounting arrangement to fix the camera mounting to a vehicle and a mounting arrangement to fix the camera to the camera mounting. When the camera is fixed to the camera mounting a mounting input is provided to the processor, wherein image capture settings associated with the mounting input are stored in the memory, and wherein capture of images by means of the image detector is controlled by the processor in accordance with the image capture settings from the memory when the mounting input is detected.

In other embodiments, there is provided a camera comprising an image detector, a processor and a memory. The processor is programmed to determine one input to the processor as representative of a mounting arrangement, wherein a motion stabilisation setting associated with that mounting arrangement is stored in the memory, and wherein images captured by means of the image detector are corrected for motion by the processor in accordance with the motion stabilisation parameter from the memory when the said one input is detected.

In other embodiments, there is provided a camera comprising an image detector, a processor, one or more motion sensors and a memory. The processor is programmed to determine from at least the one or more motion sensors one input to the processor as representative of a mounting arrangement, wherein image capture settings associated with that mounting arrangement are stored in the memory, and wherein capture of images by means of the image detector is controlled by the processor in accordance with the image capture settings from the memory when the said one input is detected.

The various embodiments described herein provide various methods and apparatus by which the mounting position of a image capture device may be used to specify what type of picture should be taken or to specify what some requirements of the pictures taken may be. Thus, different modes of mounting of an image capture device can be used whilst still obtaining reasonable images due to the functions described above that are triggered in particular mounting positions. The mounting position may be set by a user with buttons 1003-1005, may be detected automatically by mounting position buttons 307-309, or may be detected using other inputs such as those of motion sensors or by an analysis of images captured. A mixture of the above-described methods may also be used. All of the features described herein may be combined with any of the above aspects, in any combination.

1. An image capture system, comprising:
an image capture device, the image capture device comprising:
an image detector;
a plurality of user interface controls to select mounting inputs that each correspond to a plurality of mounting arrangements of the image capture device; and
a memory wherein a plurality of image capture settings associated with the mounting inputs are stored;
a processor that receives information from a selected mounting input, that accesses the associated image capture setting corresponding to the selected mounting input, and that controls image capture in accordance with the image capture setting; and
an image capture device mounting to fix the image capture device in a desired mounting arrangement on an object.

2. The image capture system of claim 1, wherein a selected one of the mounting inputs is selected by a user with the user interface controls.

3. The image capture system of claim 1, wherein one of the image capture settings comprises a motion stabilization setting.

4. The image capture system of claim 3, wherein images captured by the image detector are corrected for motion by the processor in accordance with the motion stabilization setting.

5. The image capture system of claim 1, wherein one of the image capture settings comprises a picture taking frequency that corresponds to the mounting arrangement of the image capture device.

6. The image capture system of claim 1, wherein one of the image capture settings comprises a picture exposure setting that corresponds to the mounting arrangement of the image capture device.

7. The image capture system of claim 1, wherein one of the image capture settings comprises a field of view setting that corresponds to the mounting arrangement of the image capture device.

8. The image capture system of claim 1, wherein the image capture settings for the mounting arrangement are associated with an expected use of the image capture device in that mounting arrangement.

9. The image capture system of claim 1, further comprising a harness coupled to the image capture device mounting, the harness wearable by a user.

10. The image capture system of claim 9, wherein the harness is adapted to be worn on a user's head.

11. The image capture system of claim 9, wherein the harness is adapted to be worn on a user's chest.

12. The image capture system of claim 9, wherein the harness is adapted to be worn on a user's belt.

13. The image capture system of claim 1, wherein the image capture device mounting is configured to couple the image capture device to a vehicle or a person.

14. The image capture system of claim 1, wherein the image capture device mounting further comprises a clip.

15. The image capture system of claim 1, further comprising a plurality of sensors, wherein the processor infers a mounting position from readings received from at least one of the sensors.

16. The image capture system of claim 15, wherein at least one of the sensors is a motion sensor.

17. The image capture system of claim 15, wherein at least one of the sensors is the image detector.

18. The image capture system of claim 15, wherein the inferred mounting position corresponds to a location where the image capture device is mounted on the object.

19. The image capture system of claim 1, further comprising a plurality of mounting location buttons, wherein the processor infers the mounting arrangement from readings received from at least one of the mounting location buttons.

20. The image capture system of claim 19, wherein the inferred mounting arrangement corresponds to an orientation of the image capture device.

21. The image capture system of claim 19, further comprising a mount plate configured to actuate one of the plurality of mounting location buttons based upon proximity of the mounting button to be actuated.

22. The image capture system of claim 21, further comprising a harness coupled to the mount plate, the harness wearable by a user.

23. The image capture system of claim 21, further comprising a clip coupled to the mount plate, the clip configured to fasten to the object.

24. The image capture system of claim 21, further comprising a strap coupled to the mount plate, the strap configured to fasten to the object.

25. A method of configuring image capture, the method comprising:
detecting at least one of a plurality of mounting inputs associated with mounting of an image capture device;
identifying one of a plurality of image capture settings associated with the detected mounting input; and
controlling capture of at least one image by the image capture device in accordance with the identified image capture setting.

26. The method of claim 25, further comprising selecting one of the plurality of mounting inputs.

27. The method of claim 26, wherein the selecting further comprises receiving information from a user interface on the image capture device, whereby one of the plurality of mounting inputs is specified by a user interacting with the user interface.

28. The method of claim 25, further comprising:
receiving information from a motion sensor that senses motion of the image capture device; and
determining a motion stabilization setting from the sensed motion.

29. The method of claim 28, further comprising correcting a captured image for motion in accordance with the motion stabilization setting.

30. The method of claim 25, further comprising:
receiving information from a position sensor that senses position of the image capture device; and
inferring a mounting position from the sensed position.

31. The method of claim 30, further comprising correcting a captured image in accordance with the inferred mounting position.

32. The method of claim 25, further comprising:
receiving information from an orientation sensor that senses orientation of the image capture device; and
inferring an orientation of the image capture device from the sensed orientation information.

33. The method of claim 32, wherein further comprising correcting a captured image for orientation of the image capture device in accordance with the inferred orientation.

34. The method of claim 25, further comprising determining an image capture frequency setting based upon the detected mounting input, and wherein controlling further comprises capturing images in accordance with the image capture frequency setting.

35. The method of claim 25, further comprising determining an image capture exposure setting, and wherein controlling further comprises capturing images in accordance with the image capture exposure setting.

36. The method of claim 25, further comprising determining a field of view setting, and wherein controlling further comprises capturing images in accordance with the field of view setting.

37. The method of claim 25, further comprising associating an expected use of the image capture device with the image capture settings, such that one of the image capture settings is selected to correspond to the expected use.

38. The method of claim 25, further comprising receiving a user specification of an arrangement such that the detecting of the mounting input is based upon the user specification.

39. A system for configuring image capture, comprising:
means for detecting at least one of a plurality of mounting inputs associated with mounting of an image capture device;
means for identifying one of a plurality of image capture settings associated with the detected mounting input; and
means for controlling capture of images by the image capture device in accordance with the identified image capture setting.

40. The system of claim 39, further comprising means for receiving specification from a user corresponding to an image capture device arrangement such that the means for detecting the mounting input is based upon the user specification.

41. The system of claim 39, further comprising means for mounting the image capture device on a person.

42. The system of claim 39, further comprising means for mounting the image capture device on a vehicle.

43. The system of claim 39, further comprising:
means for determining motion of the image capture device; and
means for correcting a captured image for the determined motion.

44. The system of claim 39, further comprising:
means for determining orientation of the image capture device; and
means for correcting a captured image for the determined orientation.

45. The system of claim 39, further comprising:
means for determining location of the image capture device when the image capture device is located on an object; and
means for correcting a captured image for the determined location.

46. A program for configuring image capture stored on computer-readable medium, the program comprising logic configured to perform;
receiving information from at least one of a plurality of mounting inputs associated with mounting of an image capture device;
determining one of a plurality of image capture settings associated with the received information; and
controlling capture of images by the image capture device in accordance with the determined image capture setting.

47. The program of claim 46, wherein the logic is further configured to perform receiving a user specification of an image capture device arrangement such that the determined image capture setting is based upon the user specification.

48. The program of claim 46, wherein the logic is further configured to perform:
determining motion of the image capture device; and
correcting a captured image for the determined motion.

49. The program of claim 46, wherein the logic is further configured to perform:
determining orientation of the image capture device; and
correcting a captured image for the determined orientation.

50. The program of claim 46, wherein the logic is further configured to perform:
determining location of the image capture device when the image capture device is located on an object; and
correcting a captured image for the determined location.
